(19) United States
(12) Patent Application Publication
(10) Pub. No.: US 2012/0315779 A1
(43) Pub. Date: Dec. 13, 2012

(54) CONNECTOR AND CONNECTION DEVICE FOR ELECTRONIC EQUIPMENT

(75) Inventors: Shinya Yudate, Matsuyama-shi (JP); Masanobu Ozaki, Matsuyama-shi (JP)

(73) Assignee: EX COMPANY LIMITED, Matsuyama-shi, Ehime (JP)

(21) Appl. No.: 13/579,403

(22) PCT Filed: Feb. 25, 2011
(86) PCT No.: PCT/JP2011/055008

§ 371 Date: Aug. 16, 2012

(30) Foreign Application Priority Data
Mar. 3, 2010 (JP) 2010-046103

(51) Int. Cl. H01R 13/52

(52) U.S. Cl. 439/271

(57) ABSTRACT

The length of a waterproof and dustproof connector can be reduced to decrease its occupation area so as to secure the occupied area of the circuit board for electronic equipment and so as to design the layout of the electronic equipment more freely and so as to downsize the electronic equipment. The connector for electronic equipment includes an approximately cylindrical housing 2, a support 21 provided in the form of a wall in the housing 2, a contact terminal 3 and a power terminal 4 supported by the support 21, a shell 5 mounted inside the housing 2, and a seal 6 provided along the outer circumference adjacent to the end on the connection terminal inserting side of the housing 2. Preferably, the seal 6 is welded to the housing 2 and made of a resin softer than the resin of the housing 2.

### TECHNICAL FIELD

The present invention relates to a connector and a connection device for electronic equipment with a waterproof function such as a connector assembly used for the charger connector of a mobile phone with a waterproof function.

### BACKGROUND ART

Conventionally, there is a connector assembly for a mobile phone of PLT 1 as a connection device for electronic equipment with a waterproof function. In the connector assembly of PLT 1, a contact terminal and a grounding terminal are formed in a resin housing by insert molding, a shell is installed at the front of this housing, and an oval collar seal is engaged with a connecting recess formed on the outer circumference of the housing from outside. On the seal disposed at the back of the connector assembly, an airtight recess is formed along the outer circumference of the seal. The respective airtight projections of the bottom and the top cases in which the connector assembly is placed are engaged with the airtight recess. The seal prevents water from being entered from the outside of the shell of this connector assembly while the insert molding prevents water from being entered from the inside of the shell.

### CITATION LIST

### Patent Literature

PLT1: Japanese Unexamined Patent Application Publication 2009-176734

### SUMMARY OF INVENTION

### Technical Problem

Since in the connector assembly of PLT 1 the shell is installed at the front of the housing, the length of the connector assembly is longer to have a larger occupied area. Thus, there are problems that lay out of a mobile phone is limited and that downsizing thereof is difficult. Furthermore, since the seal is disposed at the back of the connector assembly, water can penetrate and stand between the connector assembly and the bottom case and between the connector assembly and the top case, and then is more likely to penetrate in the circuit board through the engaged part of the seal.

The present invention is proposed in light of the above-mentioned problems and has an object of providing a connector and a connection device for electronic equipment capable of reducing the length of the connector to decrease its occupation area and then to expand the available portion for the electronic equipment so as to design the layout of the electronic equipment more freely and so as to downsize the electronic equipment. Another object of the present invention is to provide a connector and a connection device for electronic equipment capable of preventing water from penetrating between the case and the connector and more surely preventing water from further penetrating in the circuit board.

The connector for electronic equipment of the present invention includes an approximately cylindrical housing, a support provided in the form of a wall in the housing, a contact terminal and a power terminal supported by the support, a shell mounted inside the housing, and a seal provided along the outer circumference adjacent to the end on the connection terminal inserting side of the housing.

The above-mentioned configuration is capable of reducing the length of the connector to decrease its occupation area and then to expand the available portion for the electronic equipment so as to design the layout of the electronic equipment more freely and so as to downsize the electronic equipment. When the circuit board for a mobile phone is installed in the innermost of the connector, the occupied area of the circuit board for electronic equipment can be secured. Furthermore, a seal is provided adjacent to the end on the connection terminal inserting side of the housing, so that water can be prevented from penetrating between the case and the connector and more surely be prevented from further penetrating in the circuit board.

In the connector for electronic equipment of the present invention, the seal is welded to the housing and made of a resin softer than the resin of the housing.

The above-mentioned configuration can completely prevent water from penetrating between the housing and the seal by welding the housing and the seal. Furthermore, the housing is made of a hard resin while the seal is made of a resin softer than the resin of the housing, so that the shape of the housing can be maintained to improve the workability of the installation operation and the like and so that water can more surely be prevented from penetrating between the case and the seal by the elasticity of the seal.

The connector for electronic equipment of the present invention further includes an additional seal provided in an innermost recess surrounded by the innermost peripheral wall of the housing and the support.

For example, when the contact terminal or the power terminal are not formed in the housing by insert molding, the above-mentioned configuration can more surely prevent water from penetrating in the circuit board installed in the innermost of the connector. In this case, no complex molds are needed to reduce the cost and also the manufacturing failure rate can be reduced, and the flexibility of the shape of the connector can be improved.

In the connector for electronic equipment of the present invention, the seal projects from the end on the connection terminal inserting side of the housing to the connection terminal inserting side and can then be brought into press contact with the face of the connection terminal inserting side of the case in which the housing is placed.

In the above-mentioned configuration, water can be prevented from penetrating in the space between the seal and the case and more surely be prevented from penetrating in the circuit board. Furthermore, the seal is brought into press contact with the face of the connection terminal inserting side, so that fewer parts allow installation by easy vertical motion, for example by inserting a substrate on which the connector is mounted into the bottom case from above.

The connector for electronic equipment of the present invention further includes an elongated protrusion peripherally projecting adjacent to the end on the connection terminal inserting side of the housing and then contacting with the innermost end of the seal, a projection formed on the innermost surface of the elongated protrusion, and a wedge enabling the housing to be biased to the connection terminal inserting side by being pushed to the housing and then contacted with the projection.

In the above-mentioned configuration, the seal can easily be brought into press contact with the surface of the case by the wedge. The press contact state can be further secured to improve the waterproof increasingly. Furthermore, the seal can surely be brought into the press contact state even with no wedges in the case.

The connector for electronic equipment of the present invention includes an elongated protrusion peripherally projecting adjacent to the end on the connection terminal inserting side of the housing and then contacting with the innermost end of the seal, in which an engagement recess is formed on a part of the surface on the connection terminal inserting side of the elongated protrusion and welded to be engaged with the seal, and the seal projects from the end on the connection terminal inserting side of the housing to the connection terminal inserting side and can then be brought into press contact with the face on the connection terminal inserting side of the case in which the housing is placed.

In the above-mentioned configuration, the engagement recess is welded to be engaged with the seal, so that the anchorage strength between the seal and the elongated protrusion that is a part of the housing can be improved. When the seal is brought into press contact with the case, stably maintaining the innermost side of the seal can improve the stability of the waterproof effect by the seal being in the press contact state. Furthermore, the engagement recess partially formed can be used as a filling port when the seal is filled in the mold for formation, so that the manufacturing process can be simplified and made more efficient.

The connection device for electronic equipment of the present invention includes the connector for electronic equipment of the present invention and one and the other cases that form the case, in which the connector includes an elongated protrusion peripherally projecting adjacent to the end on the connection terminal inserting side of the housing and then contacting with the innermost end of the seal, and a projection formed on the innermost surface of the elongated protrusion, one case includes a guide guiding the elongated protrusion to a storage recess toward the connection terminal inserting side along an inclined surface, and the other case includes a wedge enabling the housing to be biased to the connection terminal inserting side by being pushed to the housing side and then contacted with the projection

In the configuration, the seal can easily be brought into press contact with the surface of the case by the wedge during the installation of the case. The press contact state can be further secured to improve the waterproof increasingly.

### Advantageous Effects of Invention

The connector and the connection device for electronic equipment of the present invention is capable of reducing the length of the connector to decrease its occupation area and then to expand the available portion for the electronic equipment so as to design the layout of the electronic equipment more freely and so as to downsize the electronic equipment. When the circuit board for a mobile phone is installed in the innermost side of the connector, the occupied area of the circuit board for electronic equipment can be secured. The connector and the connection device for electronic equipment of the present invention is capable of preventing water from penetrating between the case and the connector and preventing water from further penetrating in the circuit board.

### BRIEF DESCRIPTION OF THE DRAWINGS

FIG. 1 is a front perspective view of the connector for electronic equipment of the first embodiment according to the present invention.

FIG. 2 is a back perspective view of the connector for electronic equipment of the first embodiment, in which a circuit board is mounted.

FIG. 3 is a front view of the connector for electronic equipment of the first embodiment according to the present invention.

FIG. 4 is a side view of the connector for electronic equipment of the first embodiment according to the present invention.

FIG. 5 is a plane view of the connector for electronic equipment of the first embodiment according to the present invention.

FIG. 6 is a partially cross-sectional plane view of FIG. 3.

FIG. 7 is a cross-sectional view along the line A-A of FIG. 3.

FIG. 8 is a perspective view of the connector of the first embodiment, in which a circuit board is mounted and for which the bottom and the top cases are placed.

FIG. 9 is a front view of FIG. 8.

FIG. 10 is a plane view of FIG. 8.

FIG. 11 is a partially cross-sectional side view of FIG. 9.

FIG. 12(a) is a front view of the connector of the first embodiment, in which a circuit board is mounted and for which the bottom case is fitted and the top case is placed.

FIG. 12(b) is a partially cross-sectional side view of FIG. 12(a).

FIG. 13(a) is a front view of the connector of the first embodiment, in which a circuit board is mounted and for which the bottom and the top cases are fitted.

FIG. 13(b) is a partially cross-sectional side view of FIG. 13(a).

FIG. 14 is a perspective view of the connection device for electronic equipment of the first embodiment, which is mounted in a mobile phone body.

FIG. 15 is a back perspective view of the connector for electronic equipment of the second embodiment according to the present invention, on which a circuit board is mounted.

FIG. 16 is a front view of the connector for electronic equipment of the second embodiment according to the present invention.

FIG. 17 is a side view of the connector for electronic equipment of the second embodiment according to the present invention.

FIG. 18 is a plane view of the connector for electronic equipment of the second embodiment according to the present invention.

FIG. 19(a) is a front view of the connector of the second embodiment, in which a circuit board is mounted and for which the bottom and the top cases are placed.

FIG. 19(b) is a partially cross-sectional side view of FIG. 19(a).

FIG. 20(a) is a front view of the connector of the second embodiment, in which a circuit board is mounted and for which the bottom is fitted and the top case is placed.

FIG. 20(b) is a partially cross-sectional side view of FIG. 20(a).

FIG. 21(a) is a front view of FIG. 19(a), in which the wedge member is pushed.

FIG. 21(b) is a partially cross-sectional side view of FIG. 21(a).

FIG. 22(a) is a front view of the connector of the second embodiment, in which a circuit board is mounted and for which the bottom and the top cases are fitted.

FIG. 22(b) is a partially cross-sectional side view of FIG. 22(a).

FIG. 23 is a front perspective view of the connector for electronic equipment of the third embodiment according to the present invention.

FIG. 24(a) is a front view of the connector of the third embodiment, in which a circuit board is mounted and for which the bottom and the top cases are fitted.

FIG. 24(b) is a partially cross-sectional side view of FIG. 24(a).

FIG. 25 is a front perspective view of the connector for electronic equipment of the fourth embodiment according to the present invention.

FIG. 26(a) is a front view of the connector of the fourth embodiment according to the present invention, in which a circuit board is mounted, and for which the bottom and the top cases are fitted.

FIG. 26(b) is a partially cross-sectional side view of FIG. 26(a).

### DESCRIPTION OF EMBODIMENTS

### [The Connector and the Connection Device for Electronic Equipment of the First Embodiment]

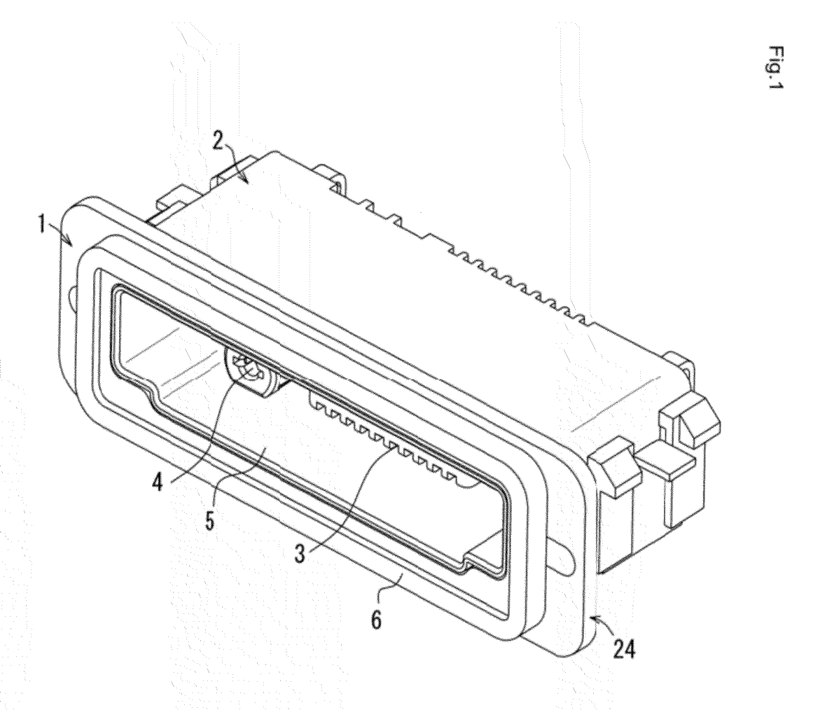

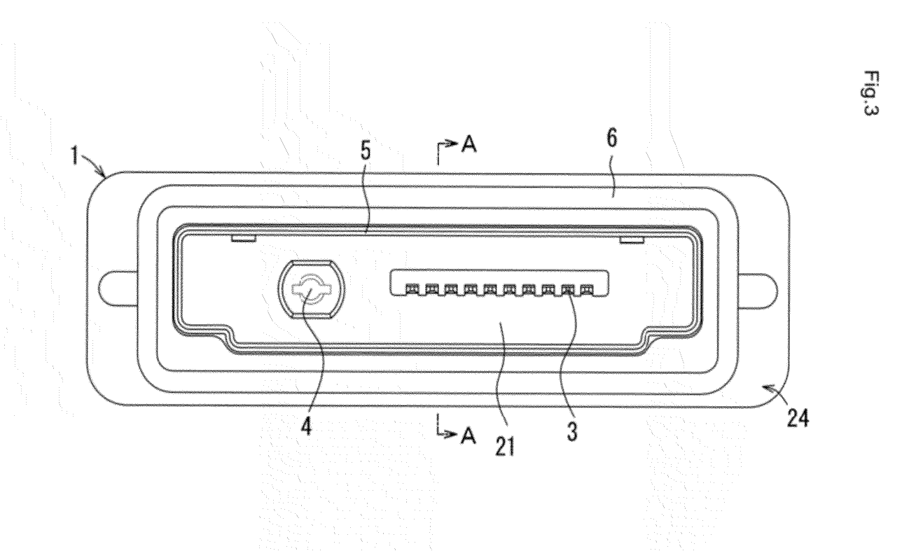

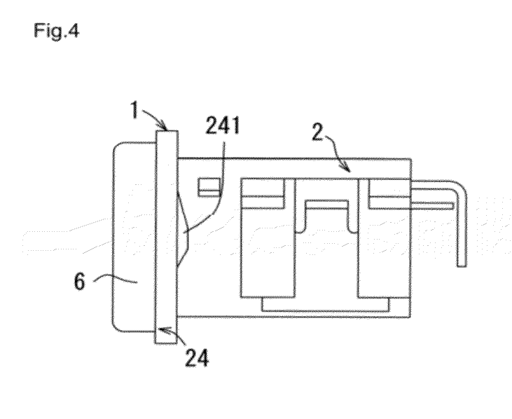

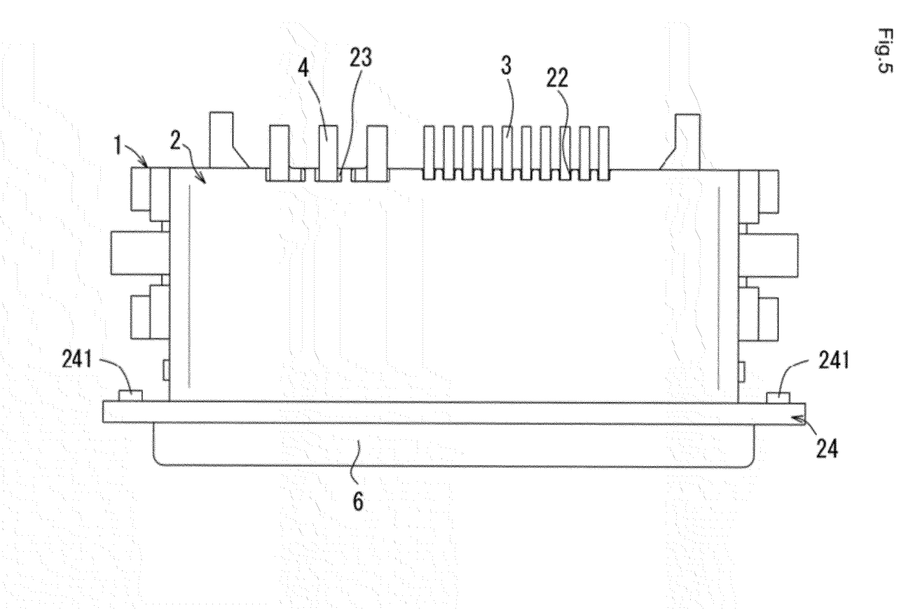

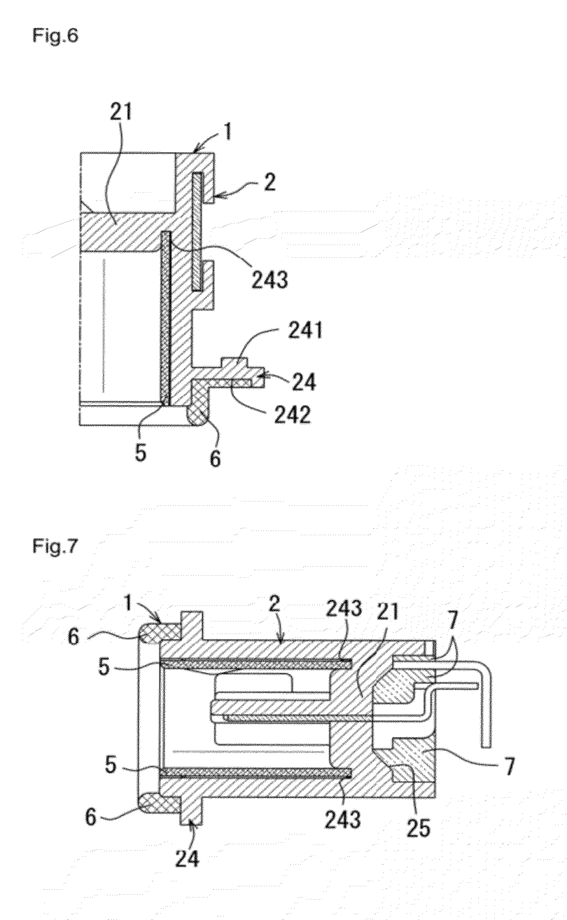

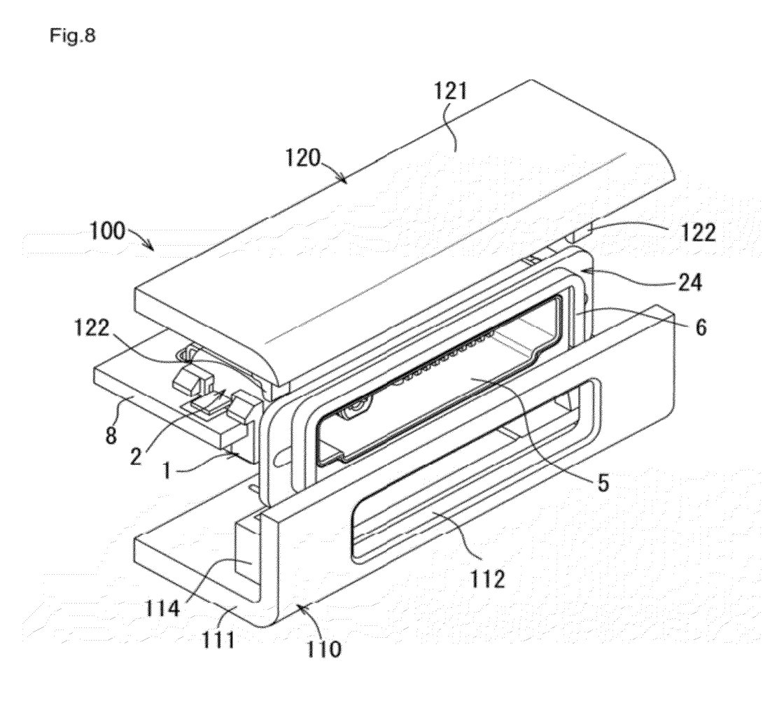

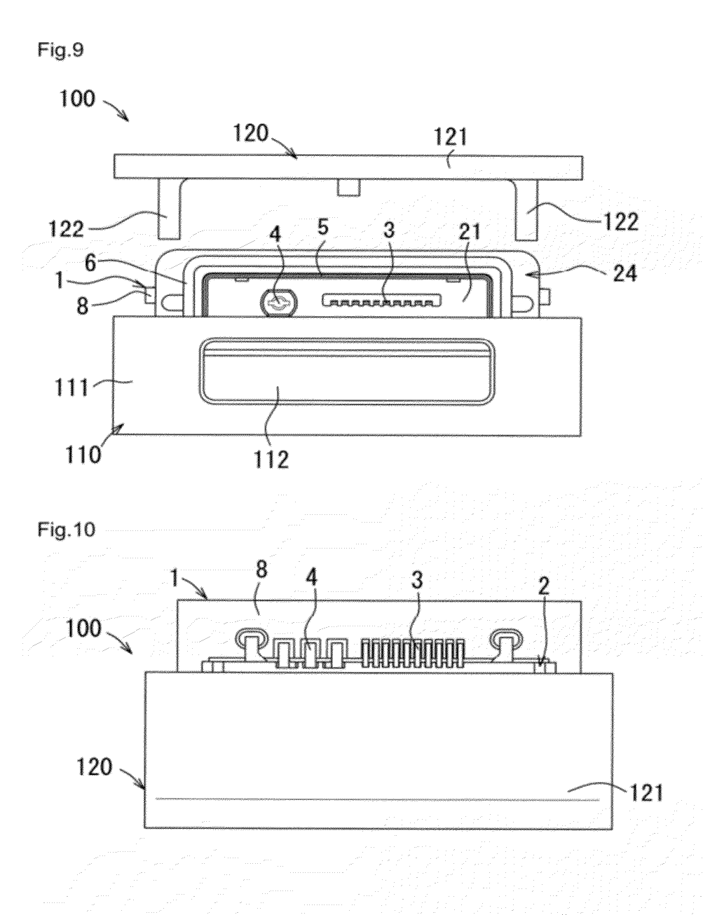

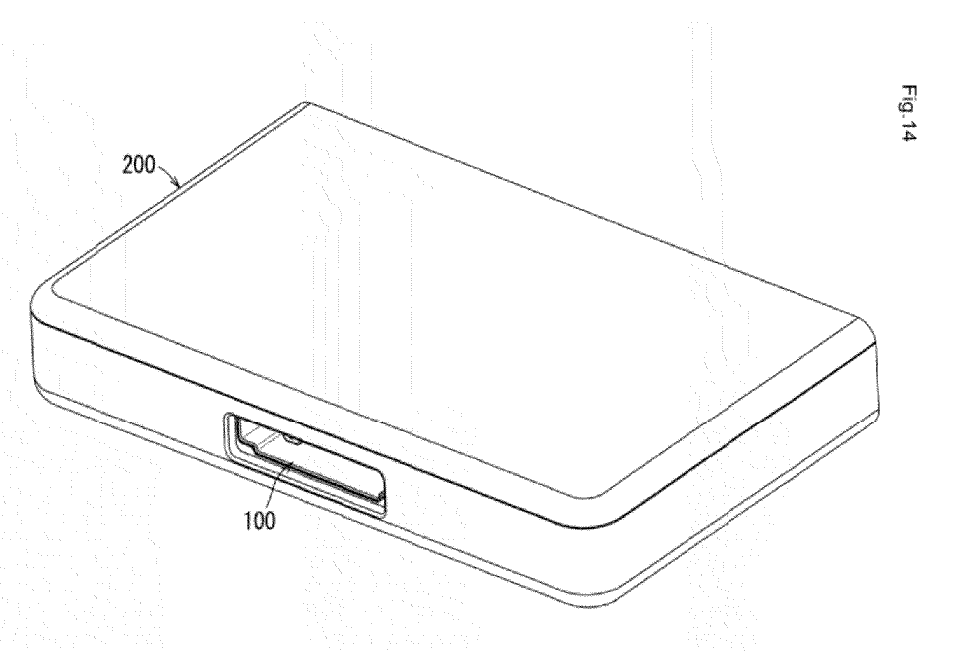

The connector and the connection device for electronic equipment of the first embodiment according to the present invention will be explained. FIGS. 1-7 illustrate the connector for electronic equipment of the first embodiment. FIGS. 8-13 illustrate the connection device for electronic equipment of the first embodiment. FIG. 14 illustrates the connection device for electronic equipment of the first embodiment, which is mounted in a mobile phone body.

As shown in FIGS. 1-7, the connector 1 for electronic equipment of the first embodiment is a connector assembly used for the charger connector of a mobile phone and the like, including an approximately cylindrical housing 2, a contact terminal 3 and a power terminal 4 inserted in the innermost of the housing 2, a shell 5 mounted inside the housing 2, and a seal 6 provided along the outer circumference adjacent to the end on the connection terminal inserting side of the housing 2.

The housing 2 is an approximately rectangular cylinder from a front view and formed of a hard resin such as a polyamide resin. In the innermost side in the housing 2, a support 21 is provided in the form of a wall to substantially close the housing 2. Through-holes 22 and 23 are formed in the support 21. The contact terminal 3 and the power terminal 4 are inserted in the through-holes 22 and 23 and are supported by the support 21. The contact terminal 3 and the power terminal 4 supported by the support 21 are inserted into the innermost of the housing 2.

Adjacent to the end on the connection terminal inserting side of the housing 2, an elongated protrusion 24 projects to the periphery and is circumferentially formed. On the right and the left sides of the innermost surface of the elongated protrusion 24, projections 241 are located respectively. Each of the projections has a gentle hill shape with either an inclined surface or a curved surface at least on the top and projects backward. The innermost end of the seal 6 described below is contacted with the surface of the connection terminal inserting side of the elongated protrusion 24. Engagement recesses 242 are formed on the respective parts of the right and the left sides of the surface on the connection terminal inserting side of the elongated protrusion 24. A part of the seal 6 is inserted in the engagement recesses 242 and then is fixed.

The shell 5 is a metallic, approximately rectangular cylinder, the outside dimension of which is the same as or slightly smaller than the inside dimension of the housing 2, and placed in the housing 2. The joint groove 243 is formed along the periphery on the connection terminal inserting side of the support 21. The innermost end of the shell 5 is fitted and installed on the joint groove 243.

The seal 6 is formed with a soft resin such as an elastomer softer than the resin of the housing 2 and welded to the housing 2. The interface between the seal and the housing 2 is melted to be integrated. The seal 6 is welded along the outer circumference adjacent to the end on the connection terminal inserting side of the housing 2 and projects from the end on the connection terminal inserting side of the housing 2 to the connection terminal inserting side. The projecting portion of this seal 6 can be brought into press contact with the surface on the connection terminal inserting side of the case in which the housing 2 is placed. The innermost end of the seal 6 is welded in contact with the surface on the connection terminal inserting side of the elongated protrusion 24. A part of the seal 6 is inserted in the engagement recesses 242 and then is welded.

As shown with two-dot chain lines of FIG. 7, in the innermost recess 25 surrounded by the innermost peripheral wall of the housing 2 and the support 21, another seal 7 such as an adhesive e.g. a bond is filled. When the contact terminal 3 and the power terminal 4 are formed in the housing 2 by insert molding, another seal 7 may not be provided.

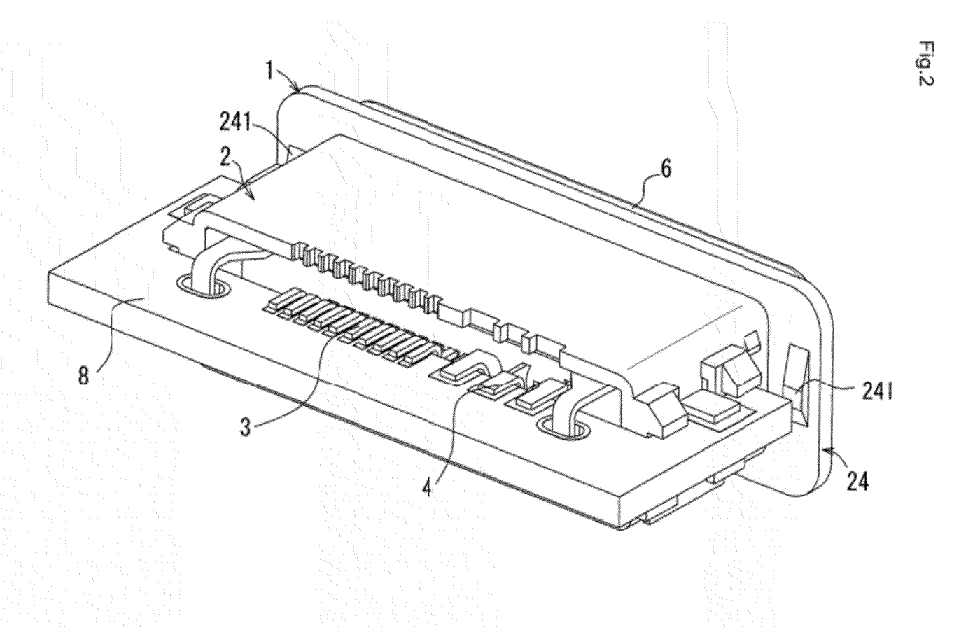

As shown in FIGS. 2 and 8-13, a circuit board 8 is disposed in the innermost of the connector 1 and is electrically connected with the contact terminal 3 and the power terminal 4 introduced from the innermost of the housing 2 respectively. The circuit board 8 of this embodiment has an approximate c-shape from a plane view and is disposed in the innermost of the housing 2 across from the right to left sides.

The connector 1 is placed in a case to form the connection device 100 as shown in FIGS. 8-13. The case of this embodiment is composed of a bottom case 110 that is the first case and a top case 120 that is a second case. The most part of the connector 1 is accommodated between the bottom case 110 and the top case 120.

The bottom case 110 includes a plate-like body 111 with an approximate L-shape from a cross-sectional view, an aperture 112 formed on the front surface of the body 111 for inserting the connection terminal, a storage recess 113 in which the lower part of the elongated protrusion 24 and the seal 6 of the connector 1 are stored, and a pair of guides 114 formed at a position near the right and the left sides of the body 111 for guiding the elongated protrusion 24 to the storage recess 113 toward the connection terminal inserting (front) side along the inclined surface. The top case 120 includes a plated body 121 with an approximately rectangular shape from a plane view, and a pair of wedges 122 projecting downward at a position near the right and the left sides of the back surface of the body 121.

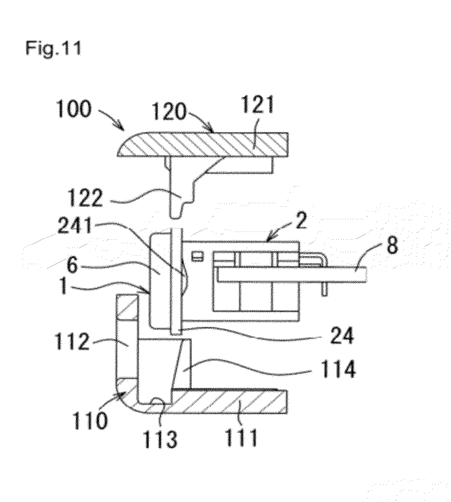

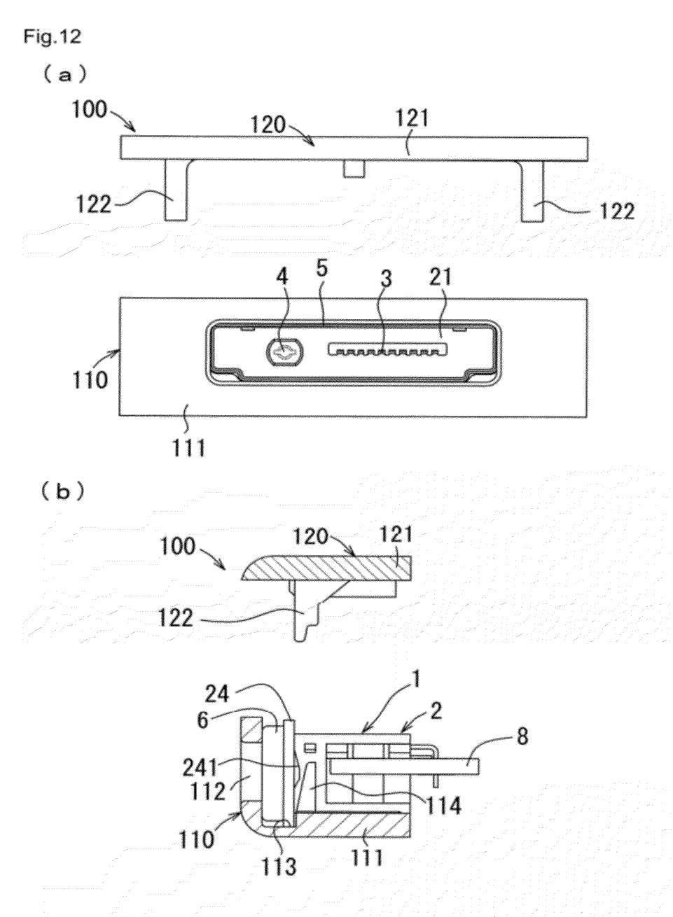

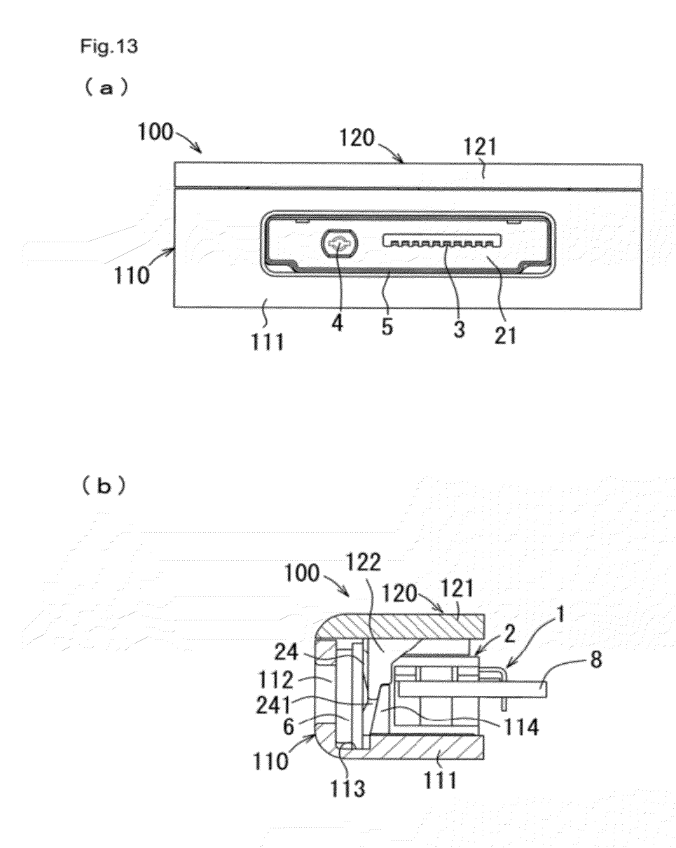

As shown in FIG. 12, in the connector 1, the elongated protrusion 24 and the seal 6 are stored in the storage recess 113 by sliding the elongated protrusion 24 in contact with the forwardly inclined surface and downward of the lower part of the guide 114, and then installed in the bottom case 110. As shown in FIG. 13, the top case 120 is pushed to the housing 2 side from above. Then, a pair of wedges 122 at the positions respectively corresponding to a pair of guides 114 and a pair of projections 241 is inserted between the corresponding guide 114 and the corresponding projection 241 and then pressed in contact with the corresponding projection 241. Accordingly, the housing 2 is biased to the connection terminal inserting side to bring the end on the connection terminal inserting side of the seal 6 into press contact with the front surface of the bottom case 110. In the above-mentioned configuration, the entire aperture 112 for inserting the connection terminal is continuously formed as an aperture on the front surface of the bottom case 110. If the respective recesses of the top and the bottom cases are matched and then an aperture is formed, water may enter from the matched part. In contrast, in the present invention, the entire aperture formed on one case or the other case for inserting the connection terminal and the configuration accomplished by the above-mentioned press contact state ensure the waterproof effect.

The connection device 100 for electronic equipment is used as, for example, a charger connector of a mobile phone body 200 shown in FIG. 14.

In the connector 1 and the connection device 100 for electronic equipment of the first embodiment, the seal 6 is provided adjacent to the end on the connection terminal inserting side of the housing, so that the length of the connector 1 can be reduced to decrease its occupation area and then to expand the available portion for the electronic equipment, so as to secure the occupied area of the circuit board 8 installed in the innermost of the connector and so as to design the layout of the electronic equipment more freely and so as to downsize the electronic equipment. Furthermore, water can be prevented from penetrating between the case and the connector 1 and more surely be prevented from further penetrating in the circuit board 8.

Water can completely be prevented from penetrating between the housing 2 and the seal 6 by welding the housing and the seal 6. Furthermore, the housing 2 is made of a hard resin while the seal 6 is made of a soft resin softer than the resin of the housing 2, so that the shape of the housing 2 can be maintained to improve the workability of the installation operation and the like and so that water can more surely be prevented from penetrating between the case and the seal 6 by the elasticity of the seal 6. For example, when the contact terminal or the power terminal is not formed in the housing 2 by insert molding but when the another seal 7 is provided, water can be more surely prevented from penetrating in the circuit board installed in the innermost of the connector 1. In this case, no complex molds are needed to reduce the cost and the manufacturing failure rate can be reduced, and the flexibility of the shape of the connector 1 can be improved.

The seal 6 is welded to be engaged with the engagement recess 242, so that the anchorage strength between the seal 6 and the elongated protrusion 24 that is a part of the housing 2 can be improved. When the seal 6 is brought into press contact with the case, stably maintaining the innermost of the seal 6 can improve the stability of the waterproof effect by the seal 6 being in the press contact state. Furthermore, the engagement recess 242 can be used as a filling port when the seal 6 is filled in the mold, so that the manufacturing process can be simplified and made more efficient. The seal 6 can easily be brought into press contact with the surface of the case by the wedge during installation and also the press contact state can be further secured to improve the waterproof increasingly. Furthermore, the seal 6 is brought into press contact with the face of the connection terminal inserting side, so that fewer parts allow installation by easy vertical motion, for example by inserting a substrate on which the connector is mounted into the bottom case 110 from above.

### [Connector and Connection Device for Electronic Equipment of the Second Embodiment]

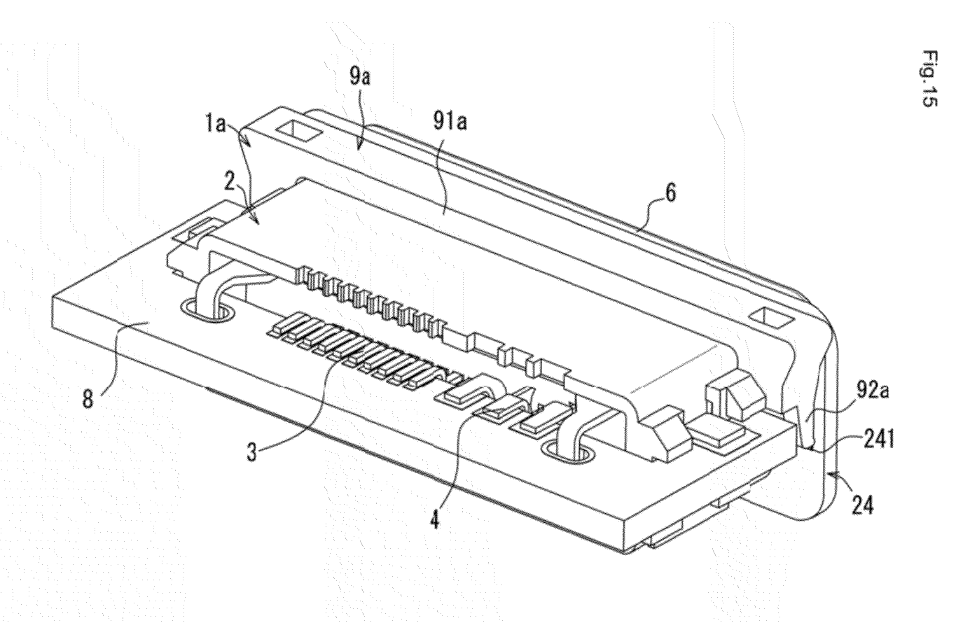

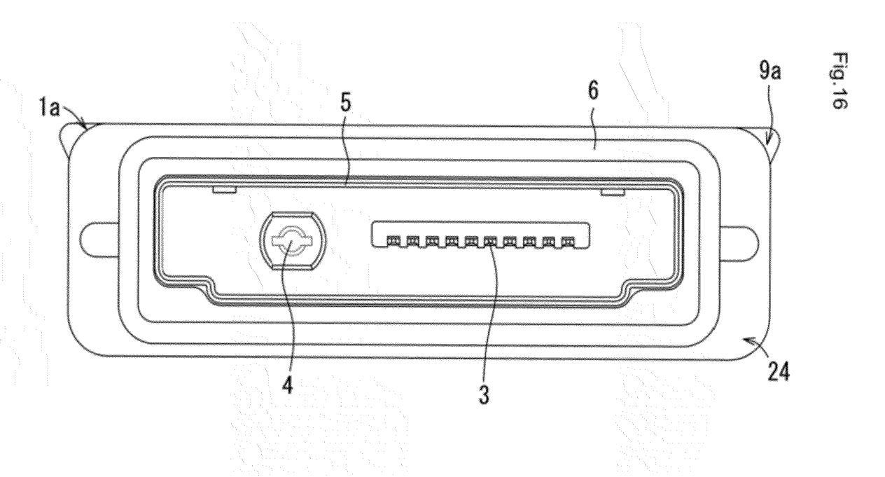

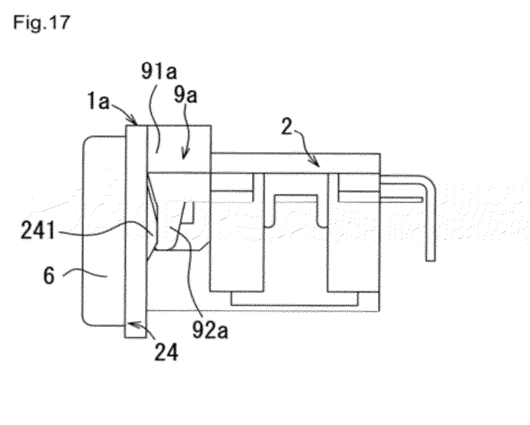

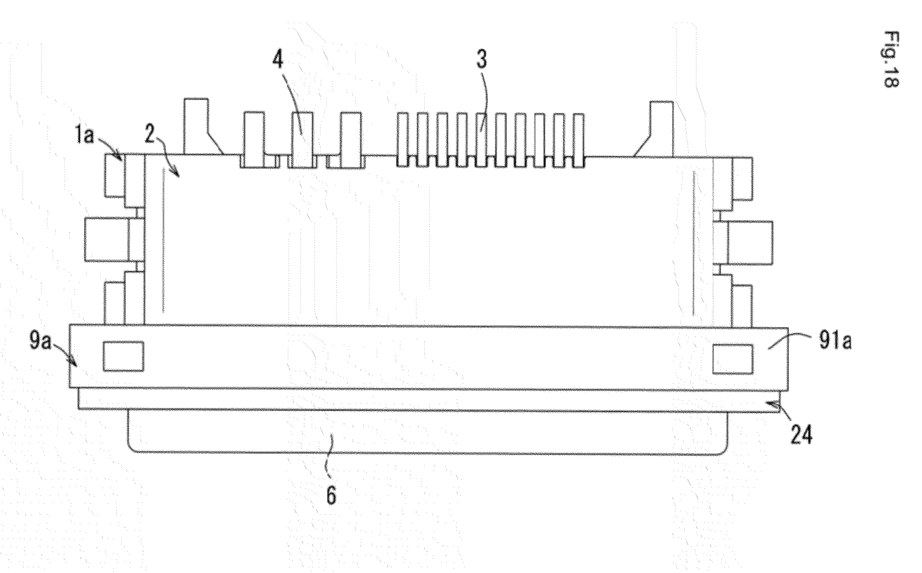

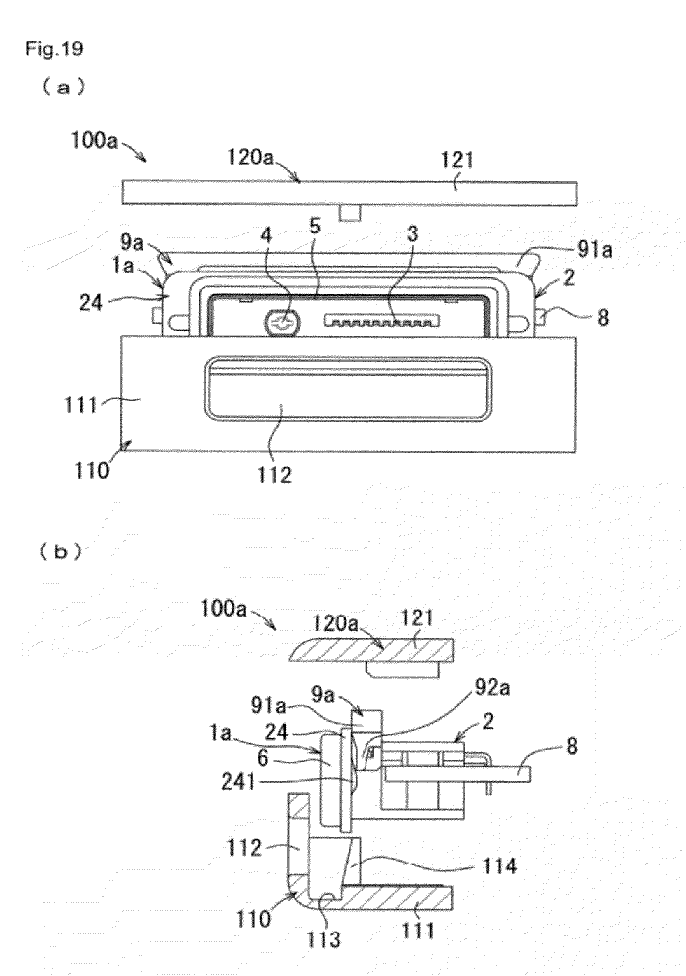

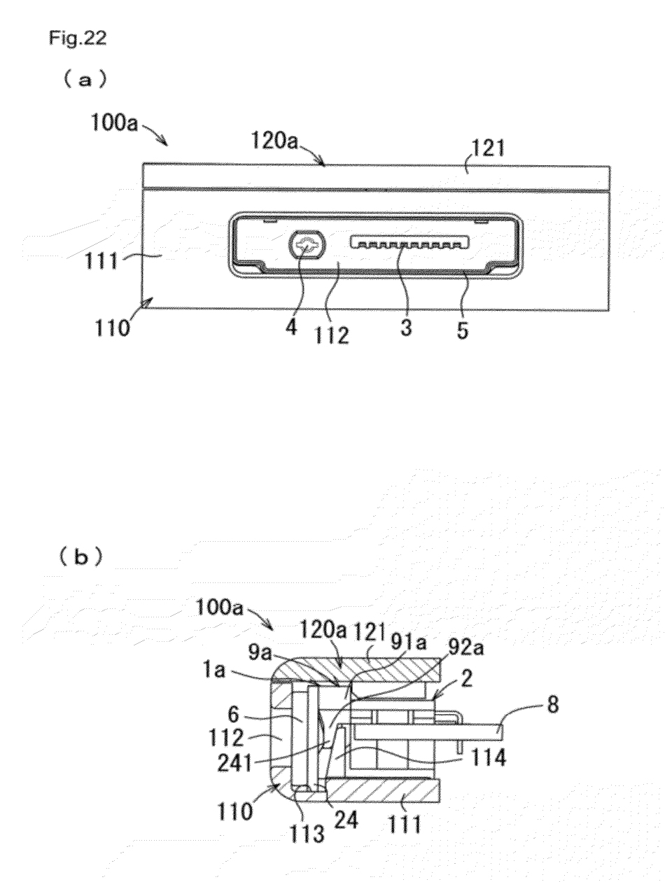

The connector and the connection device for electronic equipment of the second embodiment according to the present invention will be explained. The same description as that of the first embodiment will not be explained in particular. FIGS. 15-18 illustrate the connector for electronic equipment of the second embodiment. FIGS. 19-22 illustrate the connection device for electronic equipment of the second embodiment. As shown in FIGS. 15-18, the connector 1a for electronic equipment of the second embodiment includes a housing 2, a contact terminal 3, a power terminal 4, a shell 5, a seal 6, and an another seal 7, the configuration of which are the same as that of the first embodiment, in which a circuit board 8, the configuration of which is the same as that of the first embodiment, is installed. However, in the connector 1a, a wedge member 9a with an approximate c-shape from a front view is provided independently from a case and engaged with the housing 2 in the innermost of the elongated protrusion 24 from above. In the wedge member 9a, wedges 92a are formed at both ends of a rod-shaped base body 91a respectively. The wedges 92a are disposed to positions respectively corresponding to projections 241 located at the both sides.

The connector 1a is placed in a case to form the connection device 100a as shown in FIGS. 19-22. The case of this present embodiment is composed of a bottom case 110, the configuration of which is the same as that of the first embodiment, and the top case 120a that is the second case. In the top case 120a, the wedge 122 is removed from the top case 120 of the first embodiment.

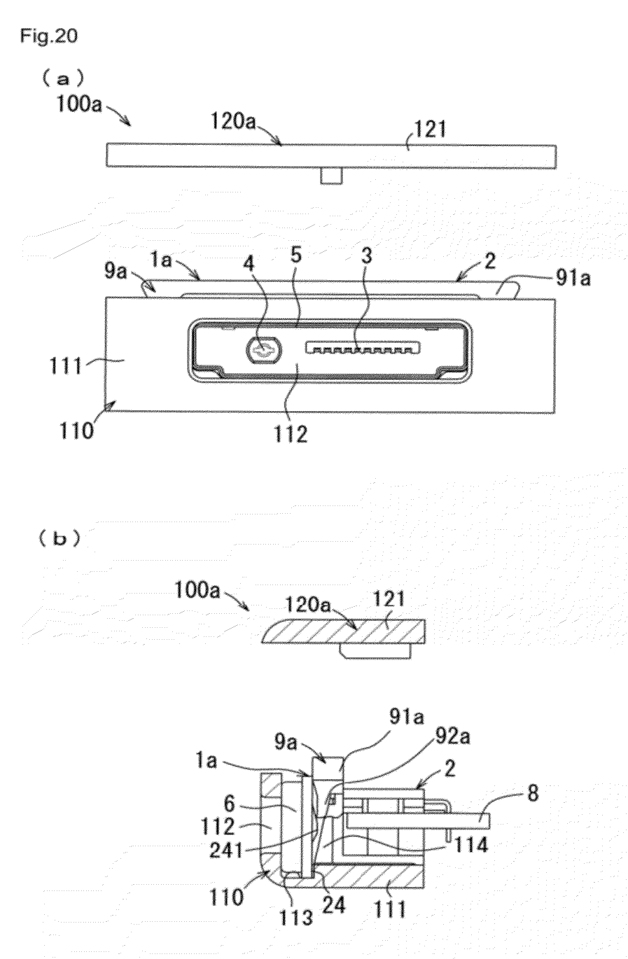

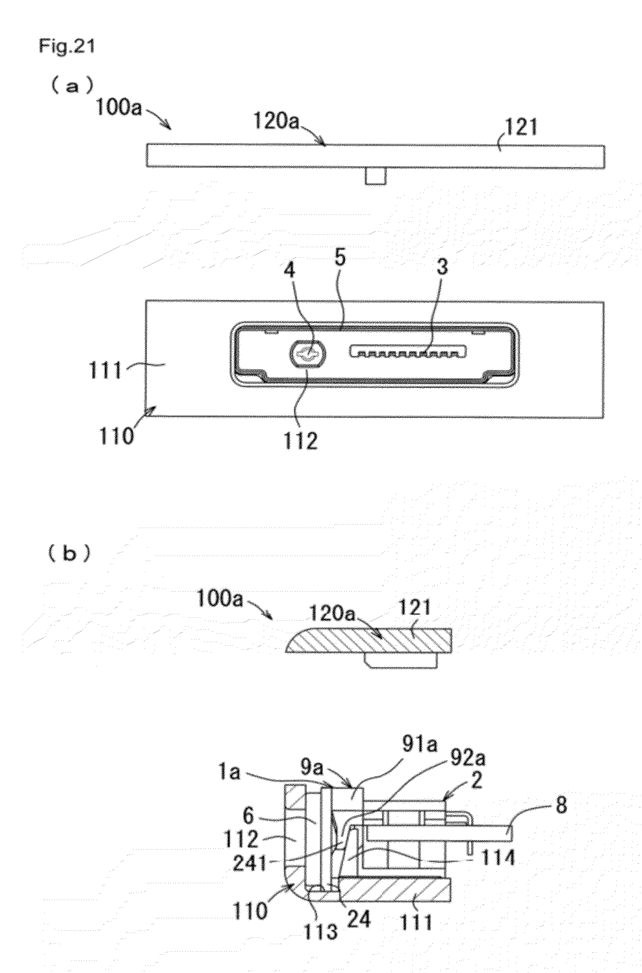

In the same way as the first embodiment, in the connector 1a, the elongated protrusion 24 and the seal 6 are stored in the storage recess 113 by sliding the elongated protrusion 24 in contact with the forwardly inclined surface inclining forward and toward the lower part of the guide 114, and then installed in the bottom case 110 (see FIGS. 19 and 20). As shown in FIG. 21, the wedge member 9a is pushed to the housing 2, and then a pair of wedges 92a at the positions respectively corresponding to a pair of guides 114 and a pair of projections 241 is inserted between the corresponding guide 114 and the corresponding projection 241 and then pressed in contact with the corresponding projection 241. Accordingly, the housing 2 is biased to the connection terminal inserting side to bring the end on the connection terminal inserting side of the seal 6 into press contact with the front surface of the bottom case 110.

Then, the top case 120a is disposed on the top surface of the housing 2 to form the connection device 100a. The wedge member 9 can be pressed in contact with the projection 241 by pushing the top case 120a to the housing 2 side from above then to make the wedge members 92a to be pushed.

In the second embodiment, the seal 6 can easily be brought into press contact with the surface of the case by the independently provided wedge member 9a. The press contact state can be further secured to improve the waterproof increasingly. Furthermore, the seal 6 can surely be brought into the press contact state even with no wedges 122 in the case. This embodiment has a corresponding effect based on the same configuration as that of the first embodiment.

### [Connector and Connection Device for Electronic Equipment of the Third Embodiment]

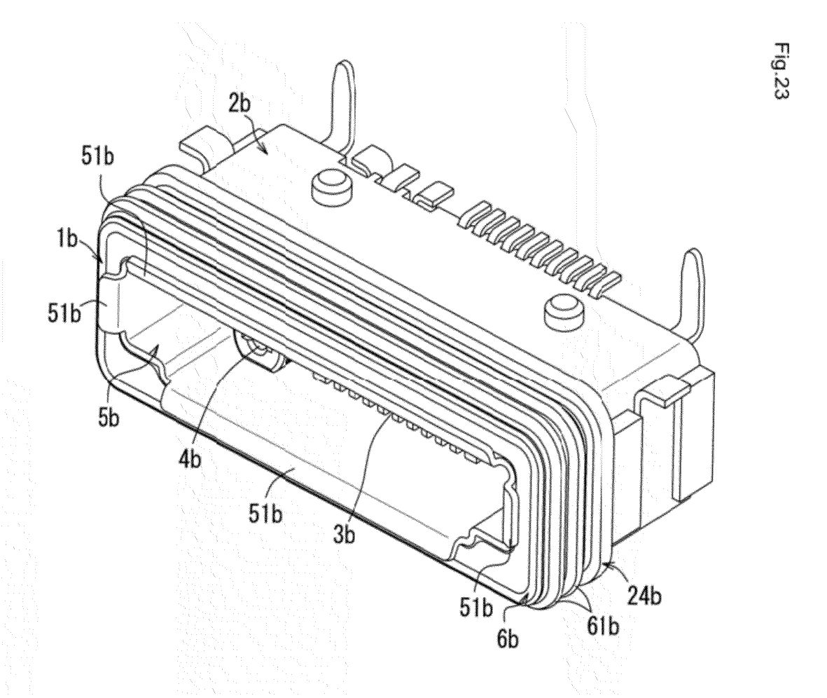

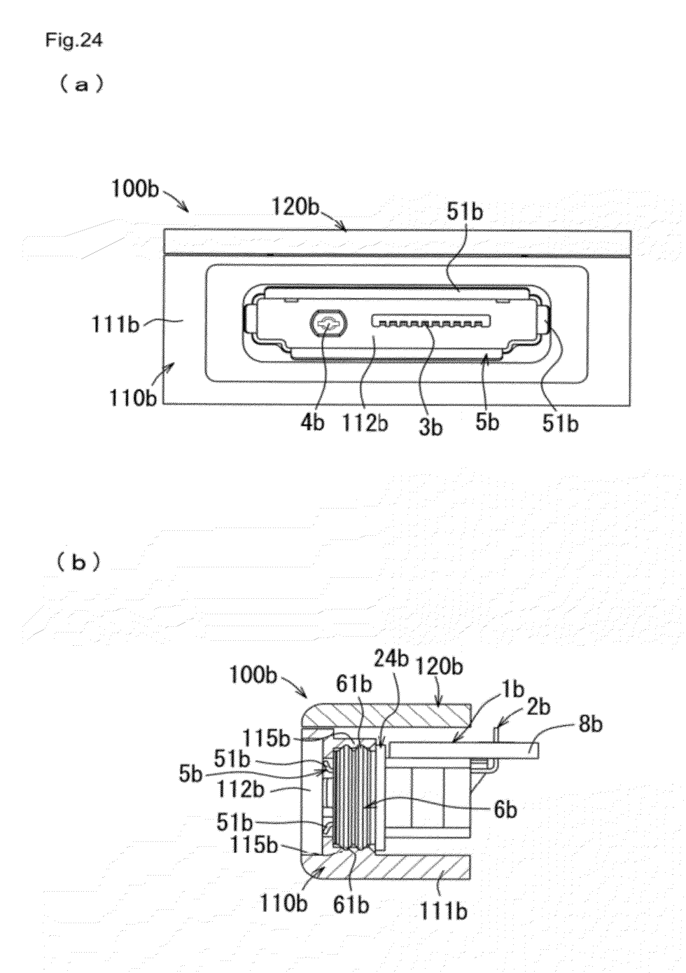

The connector and the connection device for electronic equipment of the third embodiment according to the present invention will be explained. The same description as that of the first embodiment will not be explained in particular. FIG. 23 illustrates the connector for electronic equipment of the third embodiment. FIG. 24 illustrates the connection device for electronic equipment of the third embodiment.

As shown in FIGS. 23 and 24, the connector 1b for electronic equipment of the third embodiment is a connector assembly used for the charger connector of a mobile phone and the like, including an approximately cylindrical housing 2b, a contact terminal 3b and a power terminal 4b introduced to the innermost of the housing 2b, a shell 5b mounted inside the housing 2b, and a seal 6b provided along the outer circumference adjacent to the end on the connection terminal inserting side of the housing 2b.

Adjacent to the end on the connection terminal inserting side of the housing 2b, an elongated protrusion 24b projects to the periphery and is circumferentially formed at a position further inside from the elongated protrusion 24 of the first embodiment. The length of the end of the housing 2b located at the end on the connection terminal inserting side is longer than that of the elongated protrusion 24b. The projection 241 or the engagement recess 242 of the first embodiment is not formed on the elongated protrusion 24b. The innermost end of the seal 6b described below is contacted with the surface of the connection terminal inserting side of the elongated protrusion 24b. The remaining parts of the configuration of the housing 2b are the same as those of the housing 2 of the first embodiment. Furthermore, the shell 5b is the same as the shell 5 of the first embodiment except that the shell 5b has bending tabs 51b bending outward at the connection terminal inserting side.

The seal 6b is formed with a soft resin such as an elastomer softer than the resin of the housing 2b, and welded to the housing 2b. The interface between the seal and the housing 2b is melted to be integrated. The seal 6b is welded to the outer circumference adjacent to the end on the connection terminal inserting side of the housing 2b. The end on the connection terminal inserting side extends to the approximate tip of the end of the housing 2b. The innermost end is welded in contact with the surface of the connection terminal inserting side of the elongated protrusion 24b. Furthermore, a plurality of (two in this example) peripheral projections 61b projecting outward are provided on the seal 6b. A circuit board 8b having an approximately rectangular shape from a plane view is disposed on the upper part of the connector 1b and is electrically connected with the contact terminal 3b and the power terminal 4b introduced from the innermost of the housing 2b. Another seal 7 of the first embodiment may be provided if necessary. The connector 1b is placed in a case to form the connection device 100b. The case of this embodiment is composed of a bottom case 110b that is one case and a top case 120b that is the other case. The most part of the connector 1b is accommodated between the bottom case 110b and the top case 120b.

The bottom case 110b includes a plate-like body 111b with an approximate L-shaped from a cross-sectional view, an aperture 112b formed on the front surface of the body 111b for inserting the connection terminal, and a seal socket 115b projecting circumferentially and being formed from the front surface to the innermost of the body 111b. The top case 120b is formed in the form of an approximately rectangular plate from a plane view.

In the connector 1b, the seal 6b is inserted into the seal socket 115b. Then, the seal 6b, especially the peripheral projection 61b, is brought into press contact with the inner surface of the seal socket 115b and then installed in the bottom case 110b.

Subsequently, the top case 120b covers the body 111b to form the connection device 100b. The connection device 100b can also be used as a charger connector of a mobile phone body and the like.

In the connector 1b and the connection device 100b for electronic equipment of the third embodiment, the seal 6b is provided adjacent to the end on the connection terminal inserting side of the housing 2b, so that the length of the connector 1b can be reduced to decrease its occupation area so as to design the layout of the electronic equipment more freely and so as to downsize the electronic equipment. Furthermore, water can be prevented from penetrating between the case and the connector 1b and more surely be prevented from further penetrating in the circuit board 8b.

Water can completely be prevented from penetrating between the housing 2b and the seal 6b by welding the housing 2b and the seal 6b. Furthermore, the housing 2b is made of a hard resin while the seal 6b is made of a resin softer than the resin of the housing, so that the shape of the housing 2b can be maintained to improve the workability of the installation operation and the like and so that water can more surely be prevented from being penetrating between the case and the seal 6b by the elasticity of the seal 6b. Especially, the waterproof effect between the case and the seal 6b becomes extremely improved by providing the double circumferential projections 61b on the seal 6b.

### [Connector and Connection Device for Electronic Equipment of the Fourth Embodiment]

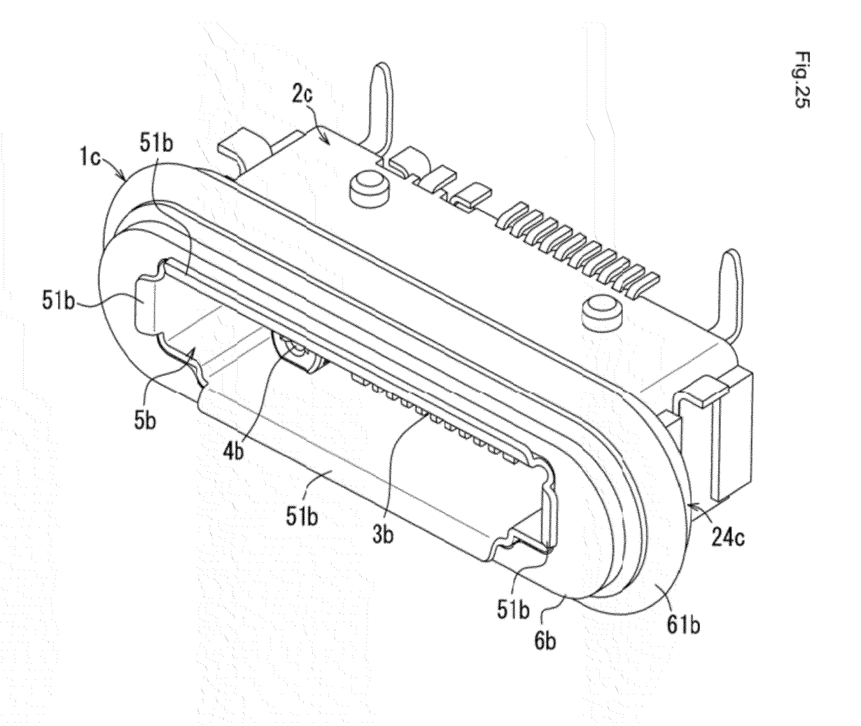

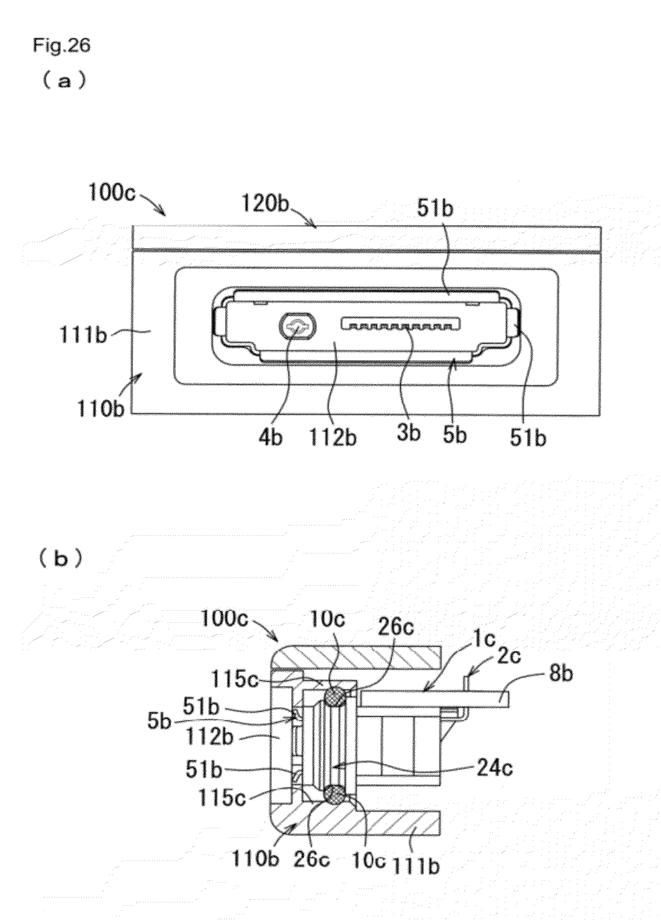

The connector and the connection device for electronic equipment of the fourth embodiment according to the present invention will be explained. The same description as that of the third embodiment will not be explained in particular. FIG. 25 illustrates the connector for electronic equipment of the fourth embodiment. FIG. 26 illustrates the connection device for electronic equipment of the fourth embodiment.

As shown in FIGS. 25 and 26, in the connector 1c for electronic equipment of the fourth embodiment, an elongated protrusion 24c projects to the periphery and is circumferentially formed adjacent to the end on the connection terminal inserting side of the housing 2c, and a groove 26c is formed adjacent to the connection terminal inserting side of the elongated protrusion 24c. An O-ring 10c is engaged with the groove 26c and brought into press contact with the inner surface of the seal socket 115b of the bottom case 110b to form the connection device 100c. The remaining parts of the configuration are the same as those of the third embodiment.

In the connector 1c and the connection device 100c for electronic equipment of the fourth embodiment, the O-ring 10c that is a seal is provided adjacent to the end on the connection terminal inserting side of the housing 2c, so that the length of the connector 1c can be reduced to decrease its occupation area. As a result, to design the layout of the electronic equipment can be realized more freely and downsizing the electronic equipment is possible. This embodiment has a corresponding effect based on the same configuration as that of the third embodiment.

[Variations from these Embodiments]

Besides configurations of each invention, each embodiment, and the like, the invention disclosed herein encompasses variations specified by modifying these partial configurations to other configurations disclosed herein, variations specified by adding other configurations disclosed herein to these configurations, and broader concepts specified by removing these partial configurations to the extent that a partial functional effect is produced. The invention disclosed herein also encompasses the following variations.

For example, the connectors 1, 1a, 1b, and 1c and the connection device 100, 100a, 100b, and 100c of the above-mentioned embodiments can be used for connecting to various kinds of electronic equipment other than a mobile phone. For example, the connectors and the connection device may be used for connecting to such as a personal computer, a portable terminal, a digital camera, and the like. The positions in which the wedges 122 and 92a, the projection 241, and the guide 114 are provided respectively are optional within the scope and the spirit of the present invention. Furthermore, the case is optional within the scope and the spirit of the present invention. For example, the case are composed of a right and left cases provided at the right and the left sides of the housing 2 respectively but not the top and the bottom.

### INDUSTRIAL APPLICABILITY

The present invention can be used for a connector for various kinds of electronic equipments such as a connector assembly for the charger connector of a mobile phone.

### SEQUENCE LISTING

1, 1a, 1b, 1c connector for electronic equipment
2, 2b housing
21 support
22, 23 through-hole
24, 24b, 24c elongated protrusion
241 projection
242 engagement recess
243 joint groove
25 innermost recess
26c groove
3, 3b contact terminal
4, 4b power terminal
5, 5b shell
51b bending tab
6, 6b seal
61b circumferential projection
7 another seal
8, 8b circuit board
9a wedge member
91a base body
92a wedge
10c O-ring
100, 100a, 100b, 100c connection device
110,110b bottom case
111,111b body
112,112b aperture for inserting connection terminal
113 storage recess
114 guide
115b seal socket
120,120a, 120b top case
121 body
122 wedge

1-7. (canceled)

8. A connector for electronic equipment comprising: an approximately cylindrical housing; a support provided in the form of a wall in the housing; a contact terminal and a power terminal supported by the support; a shell mounted inside the housing; and a seal provided along the outer circumference adjacent to the end on the connection terminal inserting side of the housing.

9. The connector for electronic equipment according to claim 8, wherein the seal is welded to the housing and made of a resin softer than the resin of the housing.

10. The connector for electronic equipment according to claim 8 further comprising an additional seal provided in an innermost recess surrounded by the innermost peripheral wall of the housing and the support.

11. The connector for electronic equipment according to claim 9 further comprising an additional seal provided in an innermost recess surrounded by the innermost peripheral wall of the housing and the support.

12. The connector for electronic equipment according to claim 8, wherein the seal projects from the end on the connection terminal inserting side of the housing to the connection terminal inserting side and can then be brought into press contact with the surface of the connection terminal inserting side of the case in which the housing is placed.

13. The connector for electronic equipment according to claim 12 further comprising an elongated protrusion peripherally projecting adjacent to the end on the connection terminal inserting side of the housing and then contacting with the innermost end of the seal; a projection formed on the innermost surface of the elongated protrusion; and a wedge enabling the housing to be biased to the terminal insertion side by being pushed to the housing side and then contacted with the projection.

14. The connector for electronic equipment according to claim 9 comprising an elongated protrusion peripherally projecting adjacent to the end on the connection terminal inserting side of the housing and then contacting with the innermost end of the seal, wherein an engagement recess is formed on a part of the surface on the connection terminal inserting side of the elongated protrusion and welded to be engaged with the seal, and the seal projects from the end on the connection terminal inserting side of the housing to the connection terminal inserting side and can then be brought into press contact with the surface on the connection terminal inserting side of the case in which the housing is placed.

15. The connection device for electronic equipment, comprising the connector for electronic equipment according to claim 12; and one and the other cases that form the case, wherein the connector includes an elongated protrusion peripherally projecting adjacent to the end on the connection terminal inserting side of the housing and then contacting with the innermost end of the seal, and a projection formed on the innermost surface of the elongated protrusion, one case includes a guide guiding the elongated protrusion to a storage recess toward the connection terminal inserting side along an inclined surface, and the other case includes a wedge enabling the housing to be biased to the terminal insertion side by being pushed to the housing side and then contacted with the projection.
